(19) United States
(12) Patent Application Publication
(10) Pub. No.: US 2012/0019856 A1
(43) Pub. Date: Jan. 26, 2012

(54) JOB TICKET CONVERSION APPARATUS AND CONVERSION METHOD THEREOF

(75) Inventor: Keita Oshima, Tokyo (JP)

(73) Assignee: CANON KABUSHIKI KAISHA, Tokyo (JP)

(21) Appl. No.: 13/180,489

(22) Filed: Jul. 11, 2011

(30) Foreign Application Priority Data
Jul. 23, 2010 (JP) 2010-166503

(51) Int. Cl. G06F 3/12

(52) U.S. Cl. 358/1.15

(57) ABSTRACT

An apparatus for converting a job ticket that designates processing by referring metadata to a job ticket that designates processing in units of pages extracts a document hierarchical structure from input content data, and extracts attached metadata in correspondence with the document hierarchical structure. The apparatus associates the extracted metadata with pages in accordance with the extracted document hierarchical structure, and converts the job ticket referring metadata to the job ticket that designates processing in units of pages, based on a result of the association.

### BACKGROUND OF THE INVENTION

1. Field of the Invention

The present invention relates to a technique for converting a job ticket to be transmitted to a printing apparatus that performs print processing.

2. Description of the Related Art

Conventionally, job ticket analysis and content data analysis are performed independently. Here, a job ticket analysis unit is provided for each printing device. There are also multiple types of page description languages (PDLs) for representing content data, and a content data analysis unit is provided for each PDL. Specifically, a printing device A is provided with a job ticket analysis unit for use by the printing device A, a PDF analysis unit, a PS analysis unit, and a PPML analysis unit. On the other hand, a printing device B is provided with a job ticket analysis unit for use by the printing device B, a PDF analysis unit, a PS analysis unit, and a PPML analysis unit. Accordingly, independently analyzing job tickets and content data enables print jobs resulting from arbitrary combinations thereof (print jobs constituted by combinations of job tickets and page description languages) to be easily processed. One reason for this is that a typical job ticket issues instructions with respect to content and printing in units of pages. Specifically, a typical job ticket describes stapling pages 1-5 and punching pages 6-8.

However, there are also job tickets that utilize metadata as a method of issuing instructions (e.g., see JDF Specification Version 1.4 (CIP4: http://www.cip4.org/)). One reason for utilizing metadata in such job tickets is to coordinate with variable data in the content data. Variable data is mainly utilized in variable data printing (VDP). There are multiple PDLs that include metadata utilized in VDP, such as PDF/VT (ISO 16612-2) and PPML 2.2 (PODi: http://ppml.podi.org/), for example.

Incidentally, there are also multiple formats for describing job tickets. In order to be compatible with the format accepted by the system processing the job tickets, processing to convert input job tickets is performed as necessary. For example, Japanese Patent Laid-Open No. 2008-015922 generates a second job ticket having a hierarchical structure from a print setting file having a nonhierarchical structure, for a system that processes job tickets having a hierarchical structure.

In coordinating content data and a job ticket utilizing metadata for a VDP job, analysis of content data and analysis of the job ticket are closely related to each other. This is because pages to which instructions described in the job ticket apply are determined by analyzing the job ticket while analyzing metadata included in content data. Therefore, analysis of VDP content and analysis of job tickets need to be performed at the same time. Thus, a printing device, for example, adopts a method such as analyzing job tickets while analyzing VDP content. This is because with VDP, in order to process a plurality of records, job ticket analysis needs to be performed repeatedly in correspondence with each record.

However, in view of the fact that there are also multiple types of devices as well as multiple types of PDLs for VDP, it is desirable for analysis of job tickets and analysis of content data to be independent, so as to enable arbitrary combinations of devices and PDLs for VDP.

Performing job ticket analysis independently from content data analysis can be achieved by converting a job ticket referring metadata to a job ticket that designates processing in units of pages.

However, with the scheme of Japanese Patent Laid-Open No. 2008-015922, the format of a job ticket is converted based only on information contained in the job ticket itself. Conversion from designation by metadata to designation in units of pages cannot be attained merely by converting the format of a job ticket based on information contained in the job ticket.

### SUMMARY OF THE INVENTION

The present invention provides an apparatus and a method for converting a job ticket that designates processing by referring metadata to a job ticket that designates processing in units of pages.

According to one aspect of the present invention, there is provided a job ticket conversion apparatus for converting a job ticket that designates processing by referring metadata generated in order to perform variable data printing for printing print material that differs in units of records constituted by a plurality of pages to a job ticket that designates processing in units of pages, the apparatus comprising: an extraction unit that extracts a document hierarchical structure from input content data, and extracts attached metadata in correspondence with the document hierarchical structure; an association unit that associates the extracted metadata with pages in accordance with the extracted document hierarchical structure; and a conversion unit that converts the job ticket referring metadata to the job ticket that designates processing in units of pages, based on a result of the association.

Further features of the present invention will become apparent from the following description of exemplary embodiments (with reference to the attached drawings).

### BRIEF DESCRIPTION OF THE DRAWINGS

FIG. 1 is a block diagram showing an example job ticket conversion system of a first embodiment.

FIG. 2 is a flowchart showing the processing flow in the job ticket conversion system of the first embodiment.

FIG. 3A is a diagram showing a job ticket designation content of content data that does not include metadata, and FIG. 3B is a diagram showing the descriptive content of the job ticket shown in FIG. 3A.

FIG. 4 is a diagram showing an example of VDP content data that includes metadata.

FIG. 5 is a diagram showing a hierarchical structure of the content data in FIG. 4, and metadata included therein.

FIG. 6A is a diagram showing an example VDP job ticket, and FIG. 6B is a diagram showing the descriptive content of the job ticket shown in FIG. 6A.

FIG. 7 is a diagram showing a job ticket output in correspondence to the job ticket shown in FIG. 6B.

FIG. 8 is a diagram showing an example describing the descriptive content of the job ticket shown in FIG. 7.

FIGS. 9A and 9B are flowcharts showing job ticket conversion (S1006) in detail.

FIG. 10 is a block diagram showing an example configuration of a job processing portion of a printer device.

FIG. 11 is a block diagram of a conversion system in a second embodiment.

FIG. 12 is flowcharts showing the processing flow in the second embodiment.

### DESCRIPTION OF THE EMBODIMENTS

Hereinafter, embodiments for implementing the invention will be described in detail with reference to the drawings.

### First Embodiment

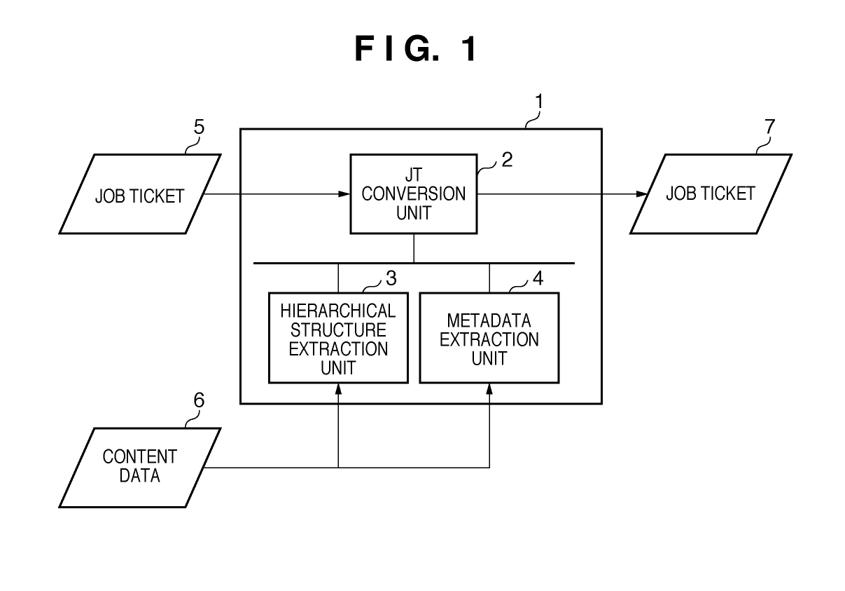

FIG. 1 is a block diagram showing an example conversion system for performing job ticket conversion of a first embodiment. In FIG. 1, a conversion system 1, in terms of hardware, is constituted by a CPU, a RAM, a ROM, a HDD and the like. Note that processing procedures (programs) indicated by the flowcharts are stored in the ROM and the HDD of the conversion system 1, and the CPU reads out processing procedures to the RAM and executes the read processing procedures. Note also that examples of the conversion system include an information processing apparatus such as a PC, and a printing apparatus, a multi-function peripheral or the like.

The conversion system 1, in terms of software, has a job ticket conversion unit 2, a hierarchical structure extraction unit 3, a metadata extraction unit 4, and the like. The job ticket conversion unit 2 inputs a job ticket 5 and outputs a job ticket 7. The hierarchical structure extraction unit 3 inputs content data 6 and extracts document hierarchical structure information of the content data 6. The metadata extraction unit 4 similarly inputs the content data 6, and extracts metadata included in the content data 6.

Here the hierarchical structure extraction unit 3 and the metadata extraction unit 4 need not have a function of analyzing all of the content data 6. In other words, the hierarchical structure extraction unit 3 takes out only the hierarchical structure constituting a document, which consists of the overall document, records for variable data printing (VDP) and units of pages, in the content data 6. With variable data printing, print material that differs in units of records (e.g., in units of customers) is printed. On the other hand, the metadata extraction unit 4 takes out only the descriptive content of metadata and information indicating to what portion of the hierarchical structure the metadata is attached. Accordingly, what content is to be printed or displayed on each page of the content data is not analyzed.

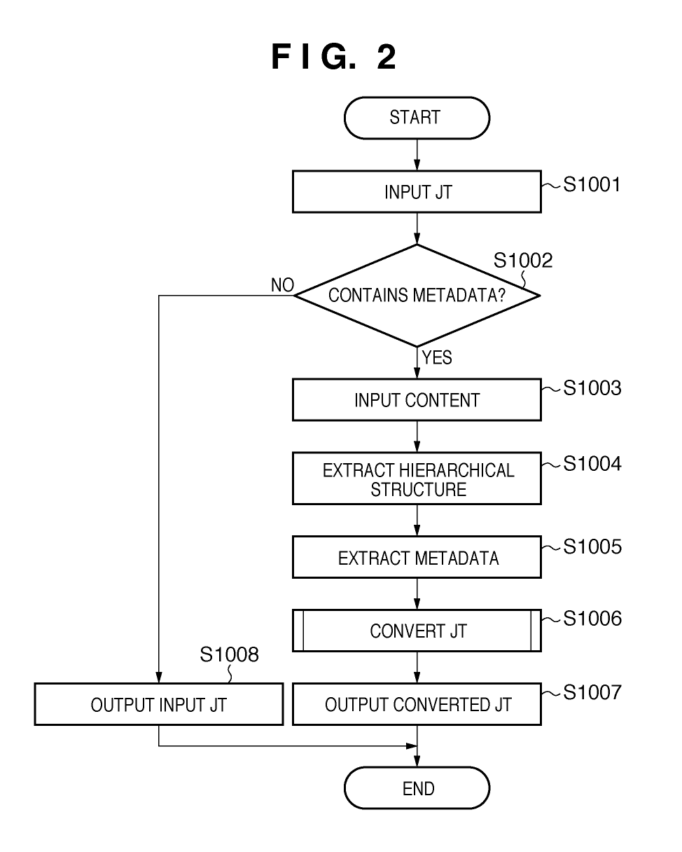

FIG. 2 is an example of a flowchart showing the processing flow in the conversion system 1 of the first embodiment. First, at S1001, the job ticket conversion unit 2 inputs a job ticket 5. Next, at S1002, the job ticket conversion unit 2 analyzes the input job ticket, and determines whether a reference to metadata is included. If the determination result is that a reference to metadata is included, the processing proceeds to S1003, and if a reference to metadata is not included, the processing proceeds to S1008.

At S1003, the hierarchical structure extraction unit 3 and the metadata extraction unit 4 input content data 6, and at S1004, the hierarchical structure extraction unit 3 extracts the hierarchical structure of the input content data. At S1005, the metadata extraction unit 4 then extracts the metadata of the input content data.

Next, at S1006, the job ticket conversion unit 2 converts the job ticket designating printing or the like using the input metadata to a job ticket designating printing or the like using page numbers. Specifically, references to metadata included in the job ticket 5 are converted to designations in units of pages, based on the information extracted from the content data 6 at S1004 and S1005. Then, at S1007, the job ticket converted from references to metadata to designations in units of pages is output.

If, at S1002, the job ticket does not include metadata, the input job ticket 5 is directly output as the job ticket 7 at S1008, since the job ticket conversion unit 2 does not need to convert the job ticket.

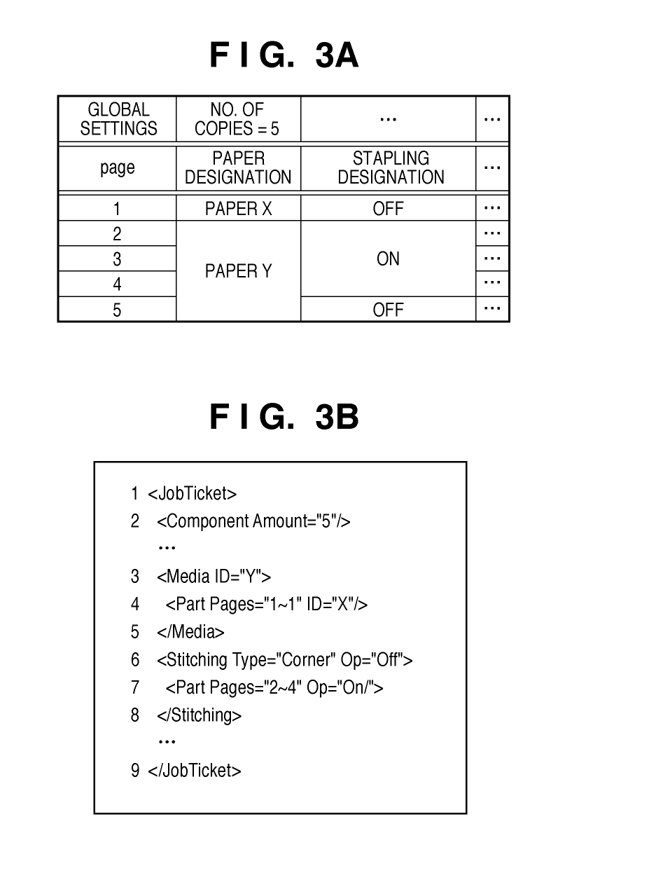

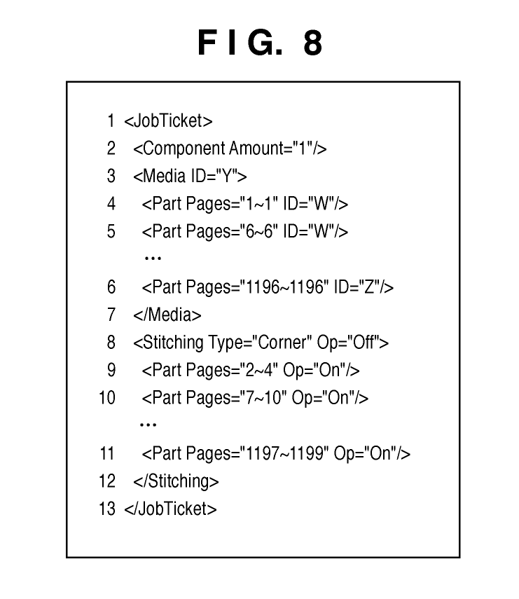

Next, job ticket conversion for converting a job ticket (S1006) will be described in detail. Note that before describing this processing, examples of a job ticket and content data in the first embodiment will be described using FIGS. 3A/3B to FIG. 8.

First, examples of content data that does not include metadata and a job ticket that is used in conjunction therewith will be described using FIGS. 3A and 3B. The job ticket includes designations relating to printing such as the number of copies to be output, paper designation, and stapling designation. This information is described as designations in units of pages or designations with respect to the overall job.

FIG. 3A shows the designation content of the job ticket. As for global settings, the number of copies is designated as five. As for the paper designation, paper X is selected for the 1st page, and paper Y is selected for the 2nd to 5th pages. With regard to stapling, a designation for partially stapling from the 2nd to 4th pages is set, rather than a designation for stapling the entire job.

FIG. 3B is an example showing the descriptive content of the job ticket in FIG. 3A. The job ticket data in FIG. 3B takes the form of a text document utilizing markup language defined in XML. Here, simplified expression of only the portions required in the description is used, and it is not intended to strictly follow XML specifications.

In FIG. 3B, the number of copies is designated on the 2nd line. The paper is designated on the 3rd to 5th lines. On the 3rd line, paper Y (ID=“Y”) is designated as a global setting. On the other hand, on the 4th line, paper X (ID=“X”) is designated from the 1st page to the 1st page (Pages=“1-1”) as a partial exceptional designation. As a result, paper X is set for the 1st page, and paper Y is set for the 2nd to 5th pages, as shown in FIG. 3A.

The stapling designation is set on the 6th to 8th lines in FIG. 3B. On the 6th line, corner (Type=“Corner”), and no stapling (Op=“Off”) is designated as a global setting. On the other hand, on the 7th line, a designation (Op=“On”) for stapling from the 2nd to 4th pages (Pages=“2-4”) is set as a partial exceptional designation. As a result, a designation for partially stapling from the 2nd to 4th pages is set, as shown in FIG. 3A.

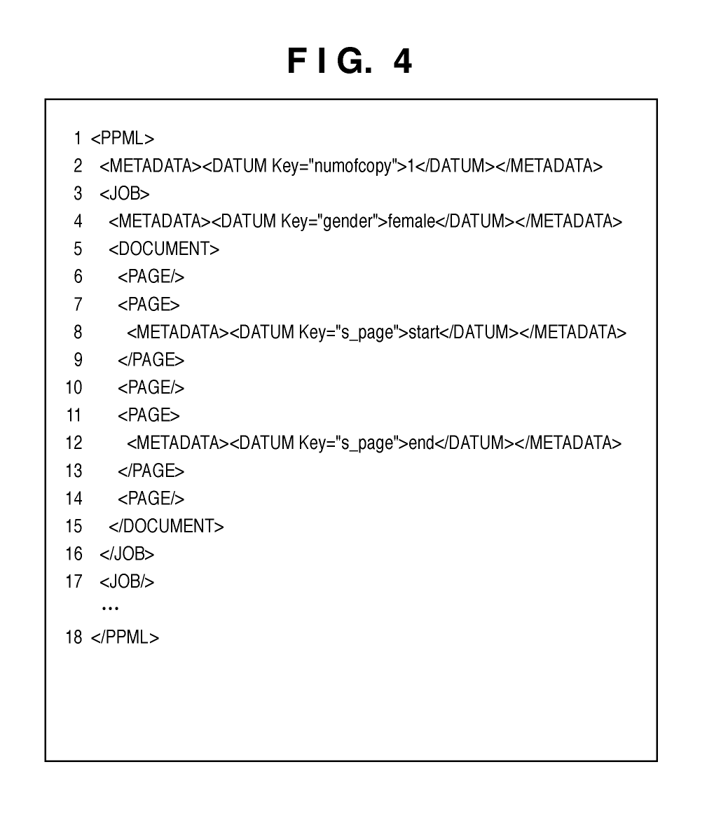

Next, an example of VDP content data that includes metadata will be described using FIG. 4. In FIG. 4, simplified expression of only portions required in the description of the first embodiment is used based on the PPML (see PPML 2.2 (PODi: http://ppml.podi.org/)). PPML represents the hierarchical structure of a document, using the hierarchical structure of XML. In FIG. 4, the value of metadata “numofcopy” is described to be “1” on the 2nd line, as a designation of metadata for the overall content data. On the fourth line, metadata “gender” is described to be “female”, as a designation of metadata for the job. Further, on the 8th to 12th lines, the values of metadata “s_page” are respectively described to be “start” and “end”, as a designation of metadata for pages. The content data shown in FIG. 4 is thus in a format describing metadata for each hierarchical level of the document.

The hierarchical level of the overall content data is below the PPML element. In the case of a VDP job for performing different printing for each customer, for example, the hierarchical level of the customer units will be the record units. The hierarchical level of the record units is below the JOB element. Further, there is a PAGE element below a DOCUMENT element, and the hierarchical level of the page units is below the PAGE element. Although omitted in FIG. 4, information regarding content data to be targeted for printing is assumed to be further described below the PAGE element.

In the example shown in FIG. 4, the description up to the 16th line represents one job, that is, one customer, and it is assumed that from the 17th line onward, description starting from the JOB element (lines 3-16) having the same structure is repeated for the number of customers.

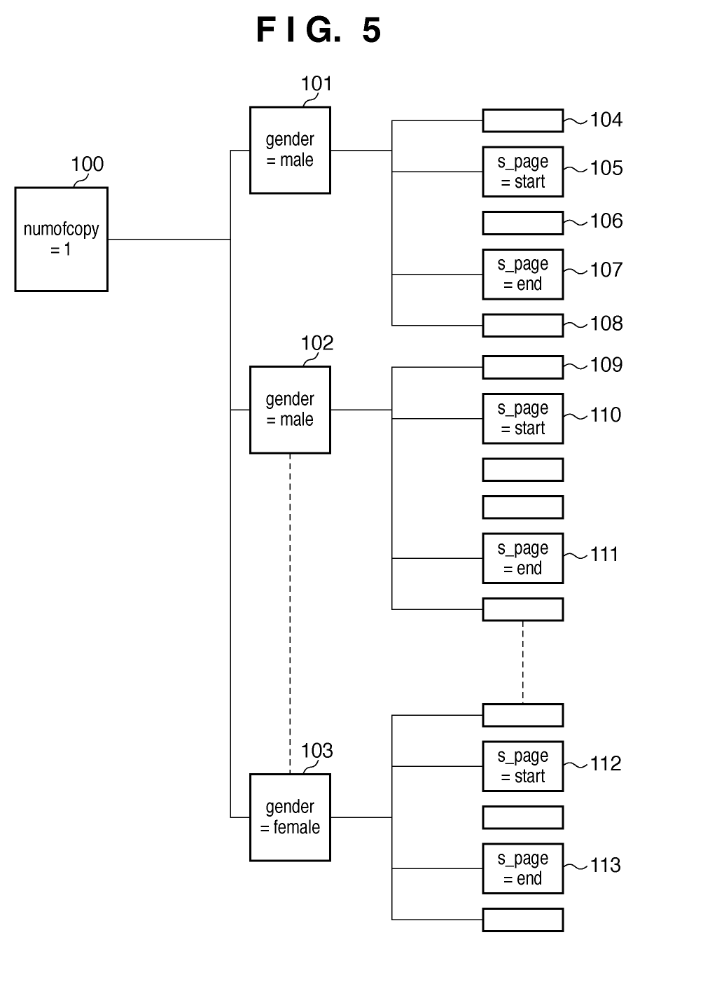

Next, the hierarchical structure of the content data shown in FIG. 4 and the metadata included in this content data will be described using FIG. 5. Here, a global level 100 of the content data is configured as shown in FIG. 5. In this example, below the global level 100 is the hierarchical level of information in units of records for VDP, with a 1st record 101, a 2nd record 102, and an nth record 103 being shown. In each of these records 101 to 103, the metadata “gender” is set to a variable value per record.

Also, below the hierarchical level of the information in record units is the hierarchical level of information in page units, with a 1st page 104 and 2nd to 5th pages 105 to 108 of the 1st record 101 being shown. A 1st page 109, a 2nd page 110 and a 4th page 111 of the 2nd record 102, and a 2nd page 112 and a 4th page 113 of the nth record 103 are also shown. Metadata “s_page” is set on pages 105, 107, 110, 111, 112 and 113. Note that the pages on which metadata is set differ depending on the record. For example, in the 1st record, metadata is set on the 2nd and 4th pages, and in the 2nd record, metadata is set on 2nd and 5th pages. This is because the number of pages may differ depending on the customer (record).

Here, in the abovementioned process of extracting the hierarchical structure (S1004), the hierarchical structure in FIG. 5 is extracted. Also, in the abovementioned process of extracting metadata (S1005), information regarding metadata is associated in accordance with the extracted hierarchical structure.

With the extraction of the hierarchical structure in the example PPML shown in FIG. 4, the hierarchical structure of content data can only be extracted by traversing prescribed elements (PPML, JOB, DOCUMENT, PAGE) in the hierarchical structure of the XML elements. Note that, while the methods differ, even with formats other than PPML the descriptive content of pages does not need to be analyzed in processing for only extracting the hierarchical structure.

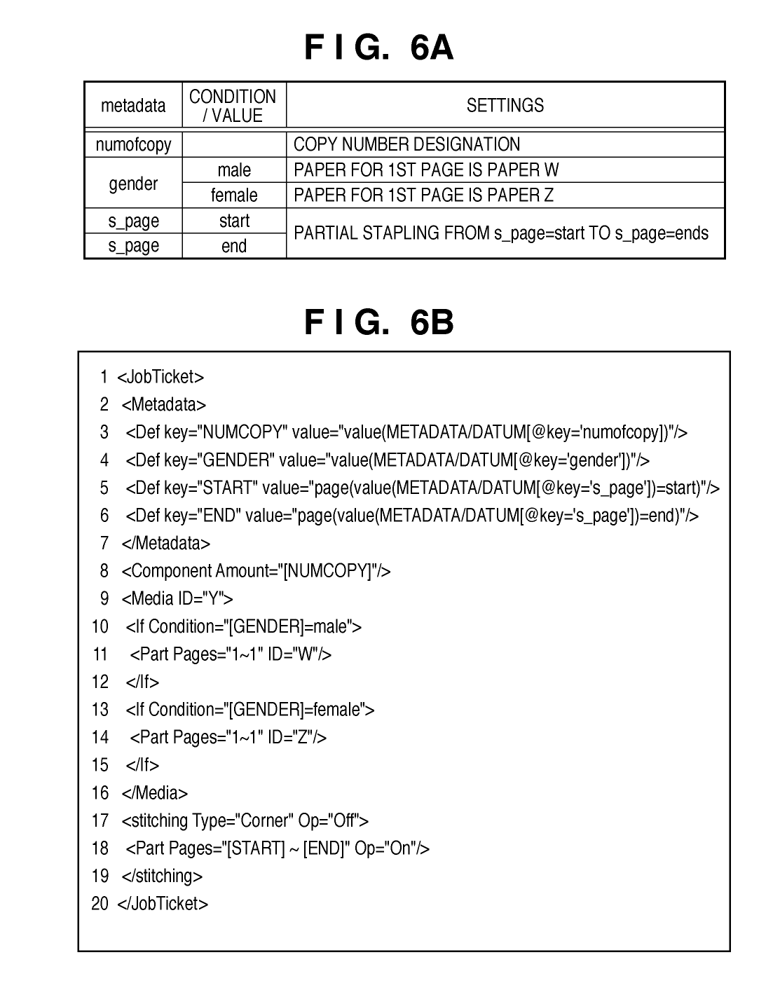

Next, an example VDP job ticket corresponding to the content data shown in FIG. 4 and FIG. 5 will be described using FIG. 6B. FIG. 6B includes the number of copies, paper designation and stapling designation, the same as the job ticket shown in FIG. 3B. The job ticket shown in FIG. 6B, however, contains references to metadata included in the content data, and utilizes this metadata to designate the printing method (usage).

FIG. 6A is a table showing the designation content of a job ticket. The value of the metadata “numofcopy” included in the content data designates the number of copies. Also, with regard to paper selection, the value of the metadata “gender” is referenced in units of records. Use of paper W for the 1st page if the gender is male, and use of paper Z for the 1st page if the gender is female is designated in the job ticket.

As for stapling, the value of the metadata “s_page” is referenced in units of records, and partial stapling is performed from the page for which the value of s_page is set to “start” to the page for which the value of s_page is set to “end”.

FIG. 6B is an example showing the descriptive content of this job ticket, which corresponds to the content in FIG. 6A. In FIG. 6B, metadata to be referenced is defined from the 2nd to 7th lines. On the 3rd to 6th lines, the metadata “numofcopy”, “gender” and “s_page” in the content data can be referenced with the terms NUMCOPY, GENDER, START and END in this job ticket. The abovementioned determination as to whether to metadata is included (S1002) is performed in accordance with whether or not description of these portions exists.

The 3rd line, having indicated the position at which the metadata “numofcopy” in the content data appears and the path in the XML hierarchy, indicates that the value of this metadata is referenced as NUMCOPY in the job ticket. Also, the 4th line describes the position at which the metadata “gender” appears and that the value thereof is referenced as GENDER. The 5th line indicates that the page with respect to which the value of the metadata “s_page” in the content data is “start” is referenced as START. The 6th line indicates that the page with respect to which the value of the metadata “s_page” in the content data is “end” is referenced as END.

The job ticket from the 8th line onward is described using the abovementioned metadata defining the reference method. The instruction method of the job ticket in FIG. 6A is the same as that shown in FIG. 3A, although the values of metadata are used for the reference portions of pages and values.

On the 8th line, the value of NUMCOPY is used as designation of the number of copies. In this example, “1” is designated as the number of copies, by corresponding with the content of the content data shown in FIG. 5. The 9th to 16th lines describe the paper designation. Selection of paper Y as the global setting for the job ticket is the same as the example shown in FIG. 3A.

The 1st page is switched between paper W and paper Z depending on the value of GENDER from the 10th to 15th lines. The 10th to 12th lines are conditional descriptions in the case of the value of GENDER being “male”, and the 13th to 15th lines are conditional description in the case of the value of GENDER being “female”. Paper that is compatible with that record can be selected while referring the value of GENDER that differs from record to record.

The 17th to 19th lines contain description of partial stapling, the same as the description shown in FIG. 3B, although the page range of the partial stapling is described using START and END. Partial stapling over a range compatible with that record is performed while referring the setting positions of “s_page” that differ from record to record.

The job ticket shown in FIG. 6B is repeatedly applied for the number of records for VDP included in the content data. In other words, it is intended that the job ticket be applied in the hierarchical units of the content data shown in FIG. 5.

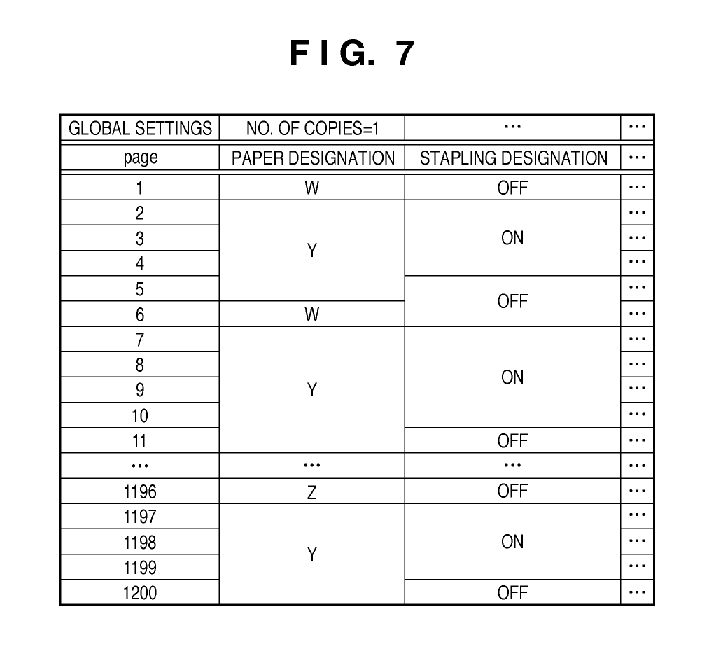

Next, the job ticket that is output will be described using FIG. 7, in the case where content data (FIG. 5) and a job ticket (FIG. 6B) are input to the job ticket conversion unit 2 in the first embodiment. FIG. 7 is a job ticket output by the job ticket conversion unit 2 in correspondence with the job ticket in FIG. 6B.

As shown in FIG. 7, the designation in units of records shown in FIG. 6A has been expanded in units of pages, and the description referring metadata has been replaced by numeric values. This results in settings such as the number of copies being constants, and the paper and stapling designations being in units of pages. Further, the job ticket is described as a single job in which all VDP records have been expanded in units of pages, rather than being designated in units of VDP records. Specifically, it is clear that the job ticket is described as designations from the 1st to 5th pages in correspondence with the 1st record 101 shown in FIG. 5, and similarly, as designations from the 6th to 11th pages in correspondence with the 2nd record 102, and as designations from the 1196th to 1200th pages in correspondence with the nth record 103.

FIG. 8 shows an example in which the job ticket shown in FIG. 7 is described in accordance with FIG. 6B.

The 8th line in FIG. 6B corresponds to the 2nd line shown in FIG. 8. The designation of the number of copies changes from a metadata reference to the numeric value “1”. Global settings of the content data that appears at levels that are not repeated are reflected as global settings of the job ticket.

The 9th to 16th lines in FIG. 6B correspond to the 3rd to 7th lines shown in FIG. 8. The JDF (Job Definition Format) description is duplicated and expanded for the number of times the level in units of records is repeated. Here, the 4th, 5th and 6th lines are expanded description.

Similar description is repeated between the 5th and 6th lines shown in FIG. 8 for number of records, although in FIG. 8 this description is omitted. It is clear that the paper for the 1st page is set to W from the value of GENDER corresponding to the 1st record on the 4th line. It is also clear that the paper for the 1196th page is set to Z from the value of GENDER corresponding to the nth record on the 6th line.

The 17th to 19th lines in FIG. 6B correspond to the 8th to 12th lines shown in FIG. 8. Similarly to the paper description, the JDF description is duplicated and expanded for the number of times the level in units of records is repeated. For example, it is clear from the values of START and END corresponding to the 1st record on the 9th line in FIG. 8 that a setting for partially stapling from the 2nd to 4th pages is configured. Similarly, the range of the partial stapling is described therebelow in units of records with page positions in the overall content data.

Thus, in the case where a job ticket designating the printing method in units of pages is input, as with the example shown in FIG. 3B, the job ticket conversion unit 2 directly outputs the input job ticket, in accordance with the flowchart shown in FIG. 2.

On the other hand, in the case where a job ticket designating the printing method using metadata is input, as with the example shown in FIG. 6B, the job ticket conversion unit 2 converts that job ticket to the job ticket shown in FIG. 8 and outputs the converted job ticket.

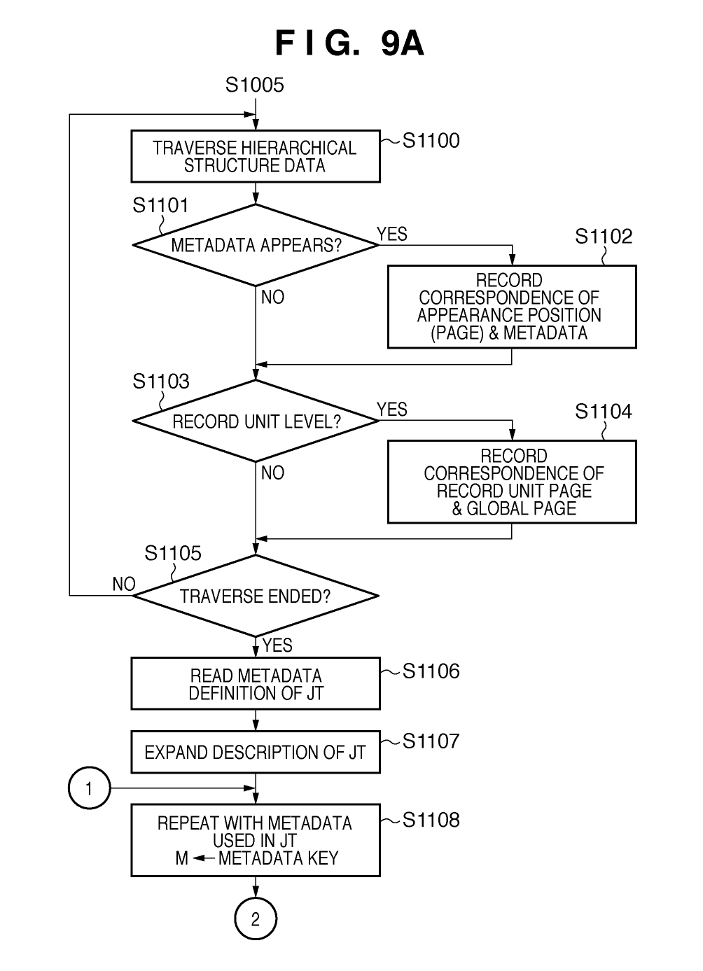

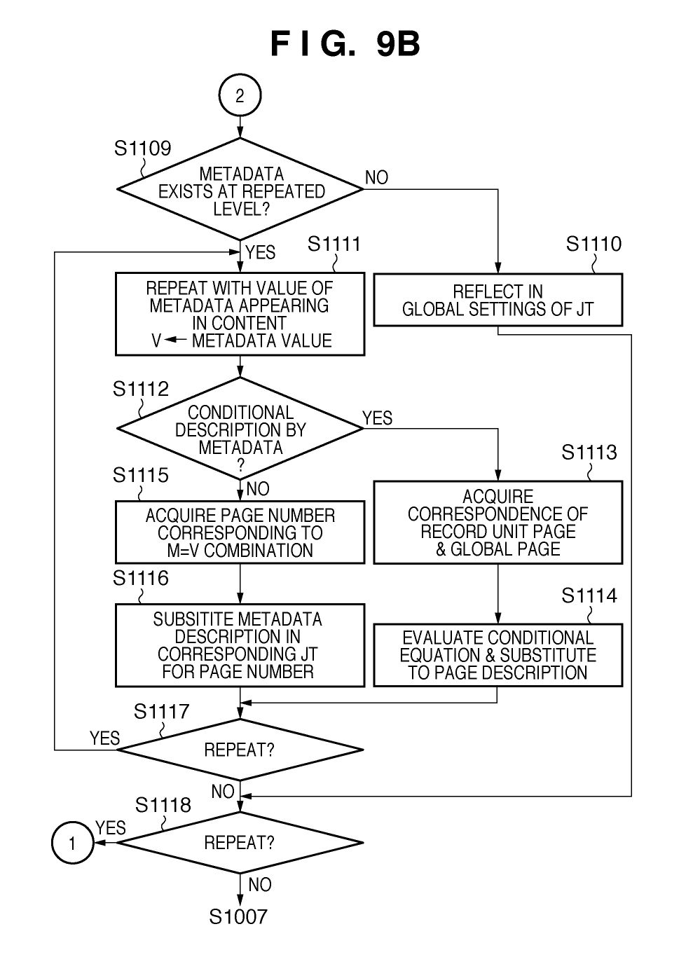

Next, the processing procedure of job ticket conversion (S1006) will be described in detail using FIGS. 9A and 9B. First, the processing of S1100 to S1105 involves a loop for traversing the hierarchical structure of the content data (FIG. 5), and investigating the correspondence of metadata and records with pages. In S1101, the job ticket conversion unit determines whether metadata is attached to nodes encountered while traversing the hierarchical structure. If there is metadata, the processing proceeds to S1102. In S1102, the job ticket conversion unit records the correspondence between metadata and pages in the overall content data, these being the positions at which the metadata appears. Specifically, after having traversed the page 105, it is recorded that the page 105 is the 2nd page of the overall document along with being the 2nd page of the 1st record, and that the metadata “s_page” is set to START. On the other hand, it is recorded that the page 110 is the 7th page of the entire document along with being 2nd page of the 2nd record, and that the metadata “s_page” is set to START.

Next, in S1103, the job ticket conversion unit determines whether the node currently being investigated is at the record unit level. If the node is at the record unit level, that is, if the node is at the level of the 1st record 101, the 2nd record 102 or the like shown in FIG. 5, the processing proceeds to S1104. At S1104, the job ticket conversion unit records the correspondence information of the page in units of records and the page in the overall content data. Taking the example shown in FIG. 5, correspondence information indicating that the 1st page 109 of the 2nd record 102 corresponds to the 6th page of the overall content data is recorded, for example. As another example, correspondence information showing that the 2nd page 112 of the nth record 103 corresponds to the 1197th page of the overall content data is recorded.

Next, at S1105, the job ticket conversion unit determines whether the traverse of the hierarchical structure has ended, and returns to S1100 if the traverse has not ended and repeats the abovementioned processing, whereas if the traverse has ended, the processing proceeds to S1106. In S1106, the job ticket conversion unit reads the definitions of metadata referenced in the job ticket. This corresponds to the 2nd to 7th lines in FIG. 6B. Further, in the first embodiment, description of this portion is here deleted from the converted job ticket.

Next, in S1107, the job ticket conversion unit expands the job ticket described in units of records so as to be described in units of pages of the overall content data. Specifically, the portion designated in units of pages is duplicated for the number of records. For example, the 10th to 15th and 18th lines in FIG. 6B are duplicated for the number of records. As a result, the basis of the 4th to 6th lines and the 9th to 11th lines shown in FIG. 8 is generated.

The processing from S1108 to S1118 is a loop for performing processing in units of the metadata read at S1106. In the example job ticket shown in FIG. 6B, the processing of NUMCOPY, GENDER, START and END is performed in order.

Next, in S1109, the job ticket conversion unit determines whether metadata to be processed is attached to a hierarchical level that is repeated. In other words, it is determined whether the metadata is a global setting of the content data. For example, in the example shown in FIG. 6B, NUMCOPY is not at a repeated hierarchical level. Metadata other than NUMCOPY appears repeatedly. Accordingly, at the time of processing NUMCOPY, the processing proceeds to S1110, and in the case of other metadata, the processing proceeds to S1111.

In S1110, the job ticket conversion unit reflects the value shown in the metadata in the global settings of the job ticket. In the example conversion from FIG. 6B to FIG. 8, the “[NUMCOPY]” description on the 8th line in FIG. 6B is replaced by “1” on the 2nd line in FIG. 8.

The processing from S1111 to S1117 is a loop for processing every piece of metadata that appears in the content data in order. Here, for convenience of description, it is assumed that the value of metadata that appears here is held in a variable V, based on information acquired at S1102.

In S1112, the job ticket conversion unit determines whether the method of referring metadata described in the job ticket is conditional description or value substitution. Here, conditional description corresponds to the 10th to 15th lines in FIG. 6B, for example. Value substitution corresponds to the 18th line in FIG. 6B. In the case of conditional description, the processing proceeds to S1113. In the case of value substitution, the processing proceeds to S1115.

For example, at the time of processing GENDER, the processing proceeds to S1113. In S1113, the job ticket conversion unit calculates what page of the overall content data the page in units of records described in the job ticket correspond to, based on the information acquired at S1104. In S1114, the job ticket conversion unit then evaluates the conditional equation of the job ticket, and makes a substitution to description in units of pages. In the example conversion from FIG. 6B to FIG. 8, the description of the 4th line shown in FIG. 8 is substituted for the description from the 10th to 12th lines of FIG. 6B, for example. The 5th line onward in FIG. 5 is similarly repeated, and substitution is performed to a corresponding page number for each record.

Also, in the case of processing START and END, for example, the processing proceeds to S1115, and based on the information acquired at S1102, the job ticket conversion unit calculates the page number having description corresponding to the metadata and value. In S1116, the job ticket conversion unit then substitutes the page number for the description of the metadata in the job ticket. In the example conversion from FIG. 6B to FIG. 8, the description on the 9th line shown in FIG. 8 is substituted for the description on the 18th line in FIG. 6B, for example. The description on the 9th line relates to after the substitution of both START and END has been completed. From the 10th line onward in FIG. 8 is similarly repeated, and substitution is performed to a corresponding page number for each record.

At S1117, the job ticket conversion unit judges whether repetition of metadata in the content has ended. At S1118, the job ticket conversion unit judges whether the repetition in units of metadata in the job ticket has ended.

As mentioned above, in the case where a job ticket such as shown in FIG. 3B is input to the job ticket conversion unit 2 in accordance with the processing procedure shown in FIG. 2, the job ticket is directly output via S1008. On the other hand, in the case where a job ticket such as shown in FIG. 6B is input to the job ticket conversion unit 2, a job ticket such as shown in FIG. 8 is output.

According to this configuration, even in the case where description referring metadata in content data is included in a job ticket, the job ticket conversion unit is always able to perform analysis in units of pages and give a control instruction in units of pages to the printer device.

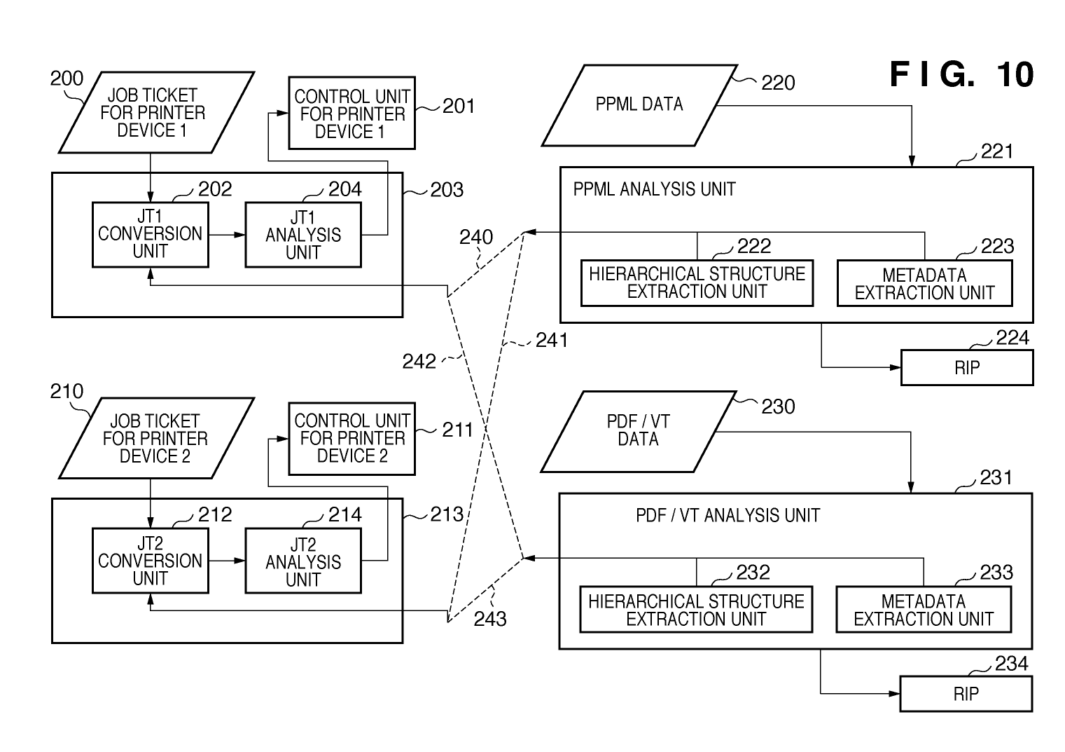

FIG. 10 is a block diagram showing an example configuration of a job processing portion of a printer device. In this example, an example configuration that is able to independently combine a plurality of printer devices (job ticket analysis units) and a plurality of PDLs is shown.

In FIG. 10, there are two types of printer devices, and control units 201 and 211 for controlling these printer devices. Job ticket processing units 203 and 213 respectively corresponding to the printer device control units 201 and 211 are provided. Job ticket conversion units 202 and 212 and job ticket analysis units 204 and 214 are provided in the job ticket processing units. One job ticket 200 is input to the job ticket conversion unit 202, and processed by the printer device control unit 201 after having passed through the job ticket processing unit 203. Another job ticket 210 is similarly input to the job ticket conversion unit 212.

In the example shown in FIG. 10, two PDLs for VDP have been provided. A PPML analysis unit 221 is required in PPML processing, and a PDF/VT analysis unit 231 is required in document conversion format (PDF/VT) processing for variable data printing. Two PDL analysis units 221 and 231 are respectively provided with hierarchical structure extraction units 222 and 232 and metadata extraction units 223 and 233. The job ticket conversion units 202 and 212 for the two printer devices are able to process metadata reference job tickets independently of the PDL analysis units. To realize this, the hierarchical structure extraction unit and the metadata extraction unit provided in the PDL analysis units that need to be combined therewith are utilized in the form of an API, for example. The dotted lines 240 to 243 indicate that the independent processes of these units can be arbitrarily combined.

### Second Embodiment

Next, a second embodiment according to the present invention will be described in detail with reference to the drawings. Since the basic configuration of the second embodiment is the same as the first embodiment, only the differences with the first embodiment will be described hereinafter.

The descriptive amount of a job ticket increases proportionately to the number of records in VDP content, as a result of a job ticket that references metadata being converted go a job ticket that designates processing in units of pages. For example, in the case of a job ticket analysis unit having a job ticket data size restriction, it may not be possible to process all of the pages.

A job ticket conversion unit 2 in the second embodiment controls the data size of a job ticket by dividing the job ticket into units of one or more records.

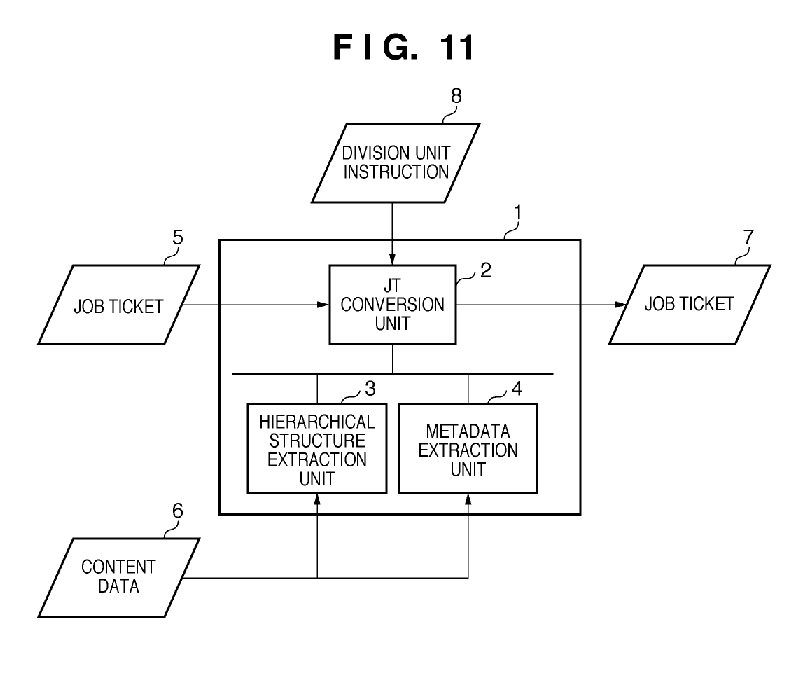

FIG. 11 is a block diagram of a conversion system in the second embodiment. The job ticket conversion unit 2 inputs a division unit instruction 8. The division unit instruction 8 is information indicating the divided size of one job ticket after conversion in units of the number of records in content data.

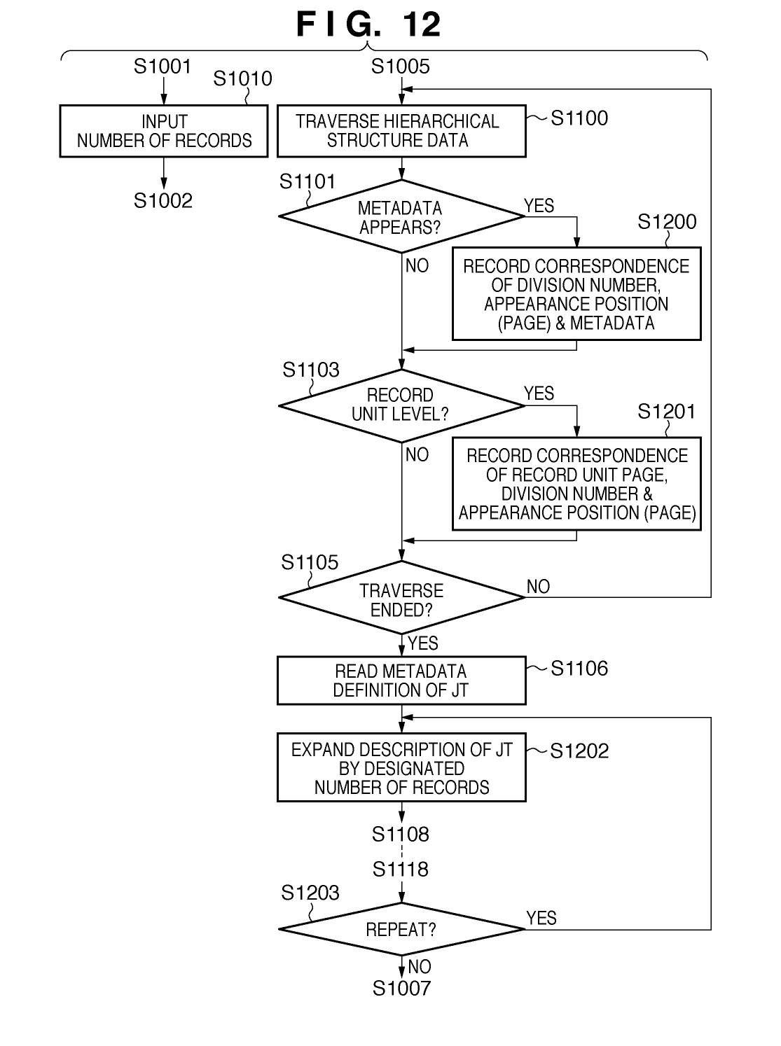

FIG. 12 is flowcharts showing the processing flow in the second embodiment. The processing of S1010 shown in FIG. 12 is a difference with respect to FIG. 2. After inputting a job ticket at S1001, the job ticket conversion unit 2, at S1010, inputs the number of records, and takes this as the job ticket division size. The processing then proceeds to S1002.

The processing of S1006 shown in FIG. 12 is a difference with respect to FIGS. 9A and 9B. Note that the same numerals are given to the same processes as FIGS. 9A and 9B. In the case where metadata is attached to a node at S1101, the processing proceeds to S1200, and the association with the page number after dividing the job ticket is recorded. In other words, the division number indicating which of the divided job tickets the page number corresponds to, and the correspondence between the page and metadata in the divided job ticket is recorded. For example, if the number of records input at S1010 is 100, the page number is reset every 100 records.

If the node is at the record unit level at S1103, the processing proceeds to S1201, and the association between the page in units of records, division number of the job ticket after dividing the job ticket and the appearance position (page) is recorded. Next, it is determined at S1105 whether the traverse has ended, and if not ended, the processing returns S1100, and the abovementioned processing is repeated.

On the other hand, if the result determined at S1105 is that the traverse has ended, the processing proceeds to S1106, and the metadata definition in the job ticket is read. Here, the processing between S1202 and S1203 is a loop for dividing the job ticket by the designated number of records. First, at S1202, the description of the job ticket is repeated for the designated number of records, and expanded so as to be page description in units of divided job tickets. Specifically, the portion forming the designation in units of pages is duplicated for the designated number of records.

The processing of the loop thereafter is similar to the processing shown in FIGS. 9A and 9B. The page number for when the job ticket description is substituted uses the value corresponding to the division number of the job ticket.

Thus, even in the case where the processible job ticket size is restricted, conversion processing of a job ticket for a VDP job of a large number of records is possible by inputting a job division unit and dividing the job ticket by the prescribed record number unit.

With the abovementioned method, since processing is performed at the description level of a job ticket, it is possible to divide and process large jobs without modifying the content analysis or job ticket analysis. According to this method, large jobs can also be divided upstream so as to be made into a size suitable for job scheduling.

According to the abovementioned first and second embodiments, dependence on content data can be eliminated by converting designation using metadata in a job ticket to designation in units of pages. Accordingly, analysis of a job ticket can be performed independently of analysis of VDP content. As a result, common job ticket analysis units can be provided for different VDP content formats.

Also, processing for extracting hierarchical structure information of content data and metadata does not need to involve analysis of the content data itself. Accordingly, content analysis does not need to be included in job ticket analysis. Job ticket analysis units and content analysis units can be separated, by providing these functions externally as partial processing of the analysis of each piece of content data.

Further, since a printer vender is able to more easily realize combining a plurality of functions with a plurality of content data formats, functions of printer products can be abundantly included. As a result, the user of a printer product is easily able to obtain a printer having desired functions.

Also, when performing function extension compatible with VDP in an existing product, correspondence can be performed by only adding a VDP content data analysis unit and a job ticket conversion unit. As a result, the user is more easily able to obtain new functions.

### Other Embodiments

Aspects of the present invention can also be realized by a computer of a system or apparatus (or devices such as a CPU or MPU) that reads out and executes a program recorded on a memory apparatus to perform the functions of the above-described embodiment(s), and by a method, the steps of which are performed by a computer of a system or apparatus by, for example, reading out and executing a program recorded on a memory apparatus to perform the functions of the above-described embodiment(s). For this purpose, the program is provided to the computer for example via a network or from a recording medium of various types serving as the memory apparatus (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-166503, filed Jul. 23, 2010, which is hereby incorporated by reference herein in its entirety.

What is claimed is:

1. A job ticket conversion apparatus for converting a job ticket that designates processing by referring metadata generated in order to perform variable data printing for printing print material that differs in units of records constituted by a plurality of pages to a job ticket that designates processing in units of pages, the apparatus comprising:
an extraction unit that extracts a document hierarchical structure from input content data, and extracts attached metadata in correspondence with the document hierarchical structure;
an association unit that associates the extracted metadata with pages in accordance with the extracted document hierarchical structure; and
a conversion unit that converts the job ticket referring metadata to the job ticket that designates processing in units of pages, based on a result of the association.

2. The apparatus according to claim 1,
wherein the association unit associates a page number of content data corresponding to the extracted metadata with the metadata, by traversing the document hierarchical structure.

3. The apparatus according to claim 1,
wherein the conversion unit expands, in units of pages, a hierarchical level of the metadata that repeatedly appears in the document hierarchical structure.

4. The apparatus according to claim 1, further comprising a unit that instructs a size for dividing the job ticket,
wherein the job ticket is divided in accordance with the instructed size.

5. A conversion method of a job ticket conversion apparatus for converting a job ticket that designates processing by referring metadata to a job ticket that designates processing in units of pages, the method comprising:
extracting a document hierarchical structure from input content data, and extracting attached metadata in correspondence with the document hierarchical structure;
associating the extracted metadata with pages in accordance with the extracted document hierarchical structure; and
converting the job ticket referring metadata to the job ticket that designates processing in units of pages, based on a result of the association.

6. A computer-readable recording medium having recorded thereon a computer program for causing a computer to execute the conversion method of a job ticket conversion apparatus for converting a job ticket that designates processing by referring metadata to a job ticket that designates processing in units of pages, the method comprising:
extracting a document hierarchical structure from input content data, and extracting attached metadata in correspondence with the document hierarchical structure;
associating the extracted metadata with pages in accordance with the extracted document hierarchical structure; and
converting the job ticket referring metadata to the job ticket that designates processing in units of pages, based on a result of the association.
